(19) United States
(12) Patent Application Publication
(10) Pub. No.: US 2017/0226978 A1
(43) Pub. Date: Aug. 10, 2017

(54) Fuel Rail

(71) Applicant: Hitachi Automotive Systems, Ltd., Hitachinaka-shi, Ibaraki (JP)

(72) Inventors: Masahiro SOMA, Hitachinaka (JP); Hiroshi ONO, Hitachinaka (JP); Keiichi URAKI, Hitachinaka (JP); Masaru KAWAI, Hitachinaka (JP); Shinya NAKATANI, Hitachinaka (JP)

(21) Appl. No.: 15/519,231

(22) PCT Filed: Sep. 4, 2015
(86) PCT No.: PCT/JP2015/075149

§ 371 Date: Apr. 14, 2017

(30) Foreign Application Priority Data
Oct. 23, 2014 (JP) 2014-215932

(51) Int. Cl. F02M 69/46; F02M 55/00

(52) U.S. Cl. CPC F02M 69/465; F02M 55/005; F02M 55/025

(57) ABSTRACT

Provided is a fuel rail that can achieve a reliable seal between a rail main unit and a cup, involving a short welding distance or a reduced amount of a brazing filler metal. In the fuel rail, a rail main unit 2 has a central hole and a rail main unit-side communication hole 10 that provides communication between the central hole and an outside of the rail main unit 2. An injector receiving member 5 has an injector insertion hole 7 into which an injector is inserted. The injector receiving member 5 is mounted in the rail main unit 2 such that the rail main unit-side communication hole 10 and the injector insertion hole 7 communicate with each other. The injector receiving member 5 has an injector receiving member-side communication hole 9 that provides communication between the rail main unit-side communication hole 10 and the injector insertion hole 7. A metal fusion zone 12 is formed, by way of an inside of the injector receiving member 5, in a bond between the rail main unit 2 and the injector receiving member 5, to thereby seal the bond.

### TECHNICAL FIELD

The present invention relates to a fuel rail for a direct injection type internal combustion engine.

### BACKGROUND ART

A recent trend in an internal combustion engine or, in particular, an automotive direct injection system using gasoline is toward improvement on combustion through further efforts made toward improved atomization of a spray injected from an injection valve (injector) as achieved by increased pressure of fuel. These efforts have been made in order to satisfy regulations and requirements imposed on exhaust emissions and fuel economy that are becoming more and more stringent every year. The fuel pressure is currently rated at 15 MPa and 20 MPa, but is expected to further increase.

Against this background, a known fuel rail forms a general rail as follows. Specifically, the general rail is formed by joining through brazing a rail main unit with parts, such as a cup on which an injector is mounted, a sensor boss to which a pressure sensor is attached, and a boss of a bolt for fixing the rail to an engine head. Unfortunately, however, lack of strength is expected in these parts and connections because of the increasing pressure.

Meanwhile, JP 2006-200454 A (PTL 1) and JP 2001-221126 A (PTL2) disclose exemplary fuel rails (common rails) for use in diesel engines.

JP 2006-200454 A (PTL 1) discloses an accumulator fuel injection system used in a diesel engine. In the accumulator fuel injection system, a joint (cup) in which a sealing member is incorporated is disposed on a flat surface portion of a rail main unit and the joint is directly welded to the rail main unit through electrification performed immediately after a high-pressure surface is generated on a sealing surface through application of a load on a step portion formed at the joint (see Abstract) .

JP 2001-221126 A (PTL 2) discloses a common rail fuel injection system used in a diesel engine. In the common rail fuel injection system, ring members (cups) are fitted onto a tubular member (rail main unit) at positions corresponding to branch holes in an outer periphery of the tubular member. Compression residual stress is applied to areas around the branch holes in an inner wall of a rail hole formed in the tubular member through a relative tightening force in a necking direction from the ring members to the tubular member. Tensile stress arising from internal pressure of pressurized fuel is thereby reduced (see Abstract).

### CITATION LIST

### Patent Literature

PTL 1: JP 2006-200454 A

PTL 2: JP 2001-221126 A

### SUMMARY OF INVENTION

### Technical Problem

To respond to the increasing pressure, common practices known in the art, as found in known common rails for diesel engines, are to increase a wall thickness of the rail main unit and to provide sealing by integrating the rail main unit with another part by forging, screwing a part, or fixing a supply pipe (joint) for supplying the injector with fuel to the rail main unit through, for example, welding of an entire periphery of the supply pipe.

In accordance with JP 2006-200454 A (PTL 1) , the rail main unit is configured to have an increased wall thickness in order to minimize deformation of the rail main unit by fuel pressure. In addition, welding the entire periphery with a diameter greater than the sealing portion enhances bonding strength of the supply pipe that supplies the injector with fuel. The configuration disclosed in JP 2006-200454 A (PTL 1) , however, results in a heavy general weight, a greater welding area, and increased cost.

With JP 2001-221126 A (PTL 2) , the rail main unit is configured to have an increased wall thickness in order to minimize deformation of the rail main unit caused by fuel pressure. Additionally, because of the approach taken toward the fixing and sealing of the ring members only by a shrink fit, an increased shrink fit amount results, so that stress generated on the supply pipe increases following the shrink fit step. This requires a large wall thickness that does not result in damage even with such large stress. A heavy general weight and increased parts cost thus result.

Piping in conventional direct injection systems is required to have an increased wall thickness and a large outside diameter. Application of a brazing process to such piping involves a large brazing area, so that a brazing filler metal is not sufficiently distributed from the outside to the inside and a portion lacking in the brazing filler metal tends to occur particularly in the inside. Fuel pressure acts on the portion lacking in the brazing filler metal to thereby cause a bond between the rail main unit and the cup to tend to be damaged. Laser welding, for example, as a possible process to be performed other than the brazing may be performed on the outer peripheral portion of the cup as a solution. This, however, involves a long welding distance, resulting in increased cost.

An object of the present invention is to provide a fuel rail that can achieve a reliable seal between a rail main unit and a cup involving a short welding distance or a reduced amount of the brazing filler metal.

### Solution to Problem

In order to achieve the above object, the present invention provides a fuel rail including: a rail main unit; and an injector receiving member, the rail main unit having a central hole, disposed at a central portion thereof, extending in an axial direction and a rail main unit-side communication hole providing communication between the central hole and an outside of the rail main unit, the injector receiving member having an injector insertion hole into which an injector is inserted, the injector receiving member being disposed in the rail main unit such that the rail main unit-side communication hole and the injector insertion hole communicate with each other, wherein the injector receiving member has an injector receiving member-side communication hole providing communication between the rail main unit-side communication hole and the injector insertion hole, and a metal fusion zone is formed, by way of an inside of the injector receiving member, in a bond between the rail main unit and the injector receiving member, to seal the bond.

### Advantageous Effects of Invention

In accordance with the aspect of the present invention, by sealing from the inside of the injector receiving member areas around the communication holes providing communication between the injector receiving member and the rail main unit, a welding distance or an amount of brazing filler metal can be reduced and sealing can be performed reliably between the injector receiving member and the rail main unit.

### BRIEF DESCRIPTION OF DRAWINGS

FIG. 1A is a cross-sectional view illustrating a general fuel rail according to a first embodiment of the present invention.

FIG. 1B is a cross-sectional view taken along line IB-IB in FIG. 1A.

FIG. 2A is an enlarged cross-sectional view illustrating a portion indicated by IIA in FIG. 1A.

FIG. 2B is an enlarged cross-sectional view illustrating a root portion of an injector cup mounting portion (enlarged cross-sectional view illustrating a portion indicated by IIB in FIG. 2A).

FIG. 3A is an enlarged cross-sectional view illustrating a laser welding condition.

FIG. 3B is an enlarged cross-sectional view illustrating a condition of the root portion of the injector cup mounting portion before the laser welding (enlarged cross-sectional view illustrating a portion indicated by IIIB in FIG. 3A).

FIG. 4A is an enlarged cross-sectional view illustrating a laser welding variation.

FIG. 4B is an enlarged cross-sectional view illustrating a welding condition after the laser welding variation of FIG. 4A (enlarged cross-sectional view illustrating a portion indicated by IVB in FIG. 4A).

FIG. 5A is an enlarged cross-sectional view illustrating part of a fuel rail according to a second embodiment of the present invention.

FIG. 5B is an enlarged cross-sectional view illustrating a portion indicated by VB in FIG. 5A (enlarged cross-sectional view illustrating a bonding state after brazing).

FIG. 5C is an enlarged cross-sectional view illustrating an injector cup mounting portion before brazing.

FIG. 5D is an enlarged cross-sectional view illustrating a brazed condition.

FIG. 6A is a view illustrating appearance of a general fuel rail according to a third embodiment of the present invention.

FIG. 6B is a cross-sectional view taken along line VIB-VIB in FIG. 6A.

FIG. 6C is a cross-sectional view illustrating the general fuel rail according to the third embodiment of the present invention (cross-sectional view taken along line VIC-VIC in FIG. 6B).

### DESCRIPTION OF EMBODIMENTS

Embodiments of the present invention will be described below with reference to the accompanying drawings. It is noted that dimensions in the drawings are exaggerated for illustrative purpose and do not represent correct scales.

### First Embodiment

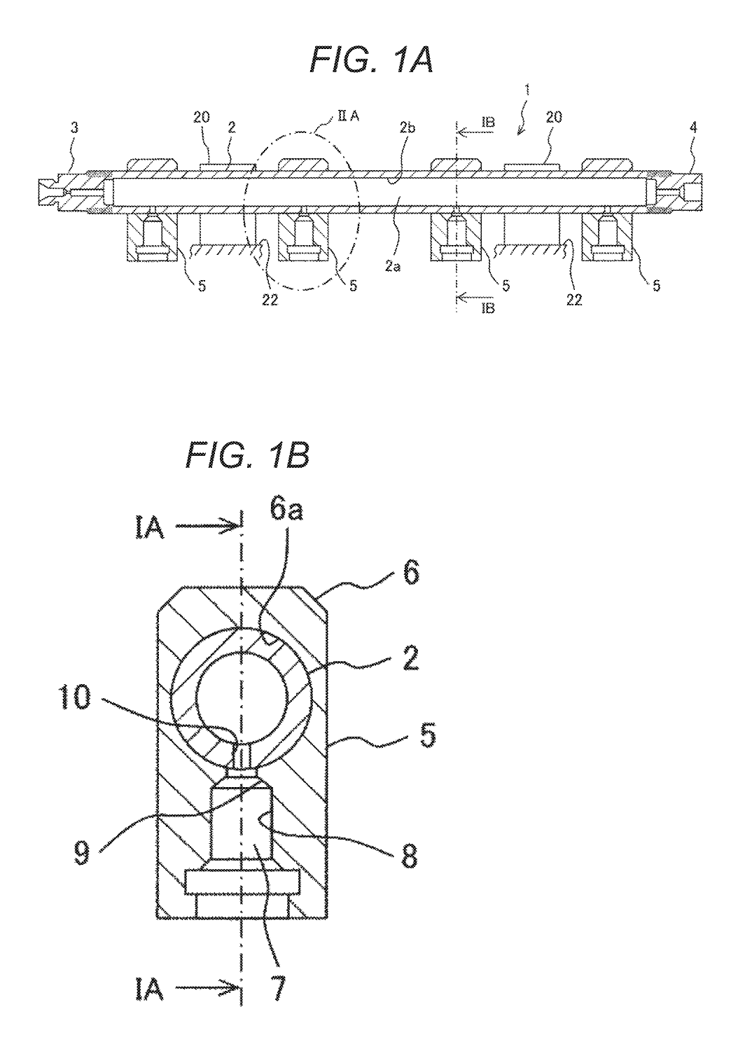

A first embodiment of the present invention will be described below with reference to FIGS. 1A to 4B.

A general configuration of the first embodiment will be described below with reference to FIGS. 1A and 1B. FIG. 1A is a cross-sectional view illustrating a general fuel rail according to the first embodiment of the present invention. FIG. 1B is a cross-sectional view taken along line IB-IB in FIG. LA. It is noted that FIG. 1A corresponds to a cross section taken along line IA-IA in FIG. 1B.

In FIG. 1A, reference number 1 denotes a high-pressure fuel rail. The high-pressure fuel rail 1 according to the present embodiment is applicable to a fuel injection apparatus used with a fuel pressure exceeding 20 MPa. The high-pressure fuel rail 1 is also applicable to a fuel injection apparatus used with a fuel pressure of 20 MPa or less. The high-pressure fuel rail 1 may be referred to simply as a fuel rail 1.

The high-pressure fuel rail 1 includes a rail main unit 2, an inlet 3, a sensor boss 4, and injector cups 5. The rail main unit has a through hole 2b formed at a central portion thereof. The through hole 2b extends in a longitudinal direction (direction in which a central axis 2a extends). The through hole 2b constitutes an accumulator (common rail) and the rail main unit 2 or the fuel rail 1 may be referred to as a common rail.

The inlet 3 is disposed at a first end portion of the rail main unit 2. The inlet 3 serves as an inlet through which high-pressure fuel is supplied from a high-pressure pump (not shown) into the rail main unit 2 (through hole 2a) via a high-pressure pipe (not shown). The sensor boss 4 is disposed at a second end portion of the rail main unit 2. A fuel pressure (not shown) for measuring fuel pressure in the rail main unit 2 is mounted in the sensor boss 4. The inlet 3 and the sensor boss 4 are each sealed with, and fixed to, the rail main unit 2 through, for example, screwing, brazing, or welding.

The rail main unit 2 includes the injector cups 5 that are equal in number to cylinders in an engine. The injector cups 5 are each an injector receiving member that receives an injector not shown. The injector cups 5 each include an embracing portion 6. The injector cups 5 are positioned correctly by the embracing portions 6 embracing therein the rail 2 in alignment with positions of injector mounting holes that are formed to be spaced apart from each other in an engine head.

In the present embodiment, the embracing portions 6 each have a through hole 6a formed therein. The through hole 6a extends in the direction in which the central axis 2a extends. The injector cups 5 are mounted on the rail main unit 2 such that the rail main unit 2 passes through the through holes 6a. The rail main unit 2 has rail main unit-side communication holes 10 formed at portions thereof at which the injector cups 5 are disposed. The rail main unit-side communication holes 10 provide communication between an inside (through hole 2a) and an outside of the rail main unit 2.

Each of the injector cups 5 has an injector insertion hole 7, an injector sealing surface 8, and a cup-side communication hole 9. Specifically, the injector insertion hole 7 receives an injector (not shown) inserted therein. The injector sealing surface 8 seals fuel via the injector and an O-ring. The cup-side communication hole 9 is disposed at an inside of an upper portion of the injector sealing surface 8. The cup-side communication hole 9 allows fuel from the rail 2 to pass therethrough. The injector sealing surface 8 is formed by an inner peripheral surface of the injector insertion hole 7. When the injector cups 5 are mounted on the rail main unit 2, the injector cups 5 are positioned with respect to the rail main unit 2 such that the rail main unit-side communication holes and the respective cup-side communication holes 9 communicate with each other.

The high-pressure fuel rail 1 is fixed to an engine 22 via brackets 20 that are fixed to the rail main unit 2 or the injector cups 5 through, for example, welding. The high-pressure fuel rail 1 holds the injectors between the injector cups 5 and the injector mounting holes in the engine head.

Fuel supplied by the high-pressure pump and the high-pressure pipe is supplied into the rail 2 (through hole 2b) via the inlet 3 and supplied into the injector cups 5 via the rail main unit-side communication holes 10 and the cup-side communication holes 9. The fuel (high-pressure fuel) supplied into the injector cups 5 is supplied into the injectors in time with valve opening of the injectors. Pressure inside a fuel chamber that extends from the rail main unit 2 to the inside of the injector cups 5 via the communication holes 9 and 10 is maintained at fuel pressure controlled by the high-pressure pump.

The fuel pressure of late direct injection systems ranges from 15 MPa to 20 MPa. The rail 2, the injector cups 5, and other parts are set to have a wall thickness and formed of a material to withstand the fuel pressure.

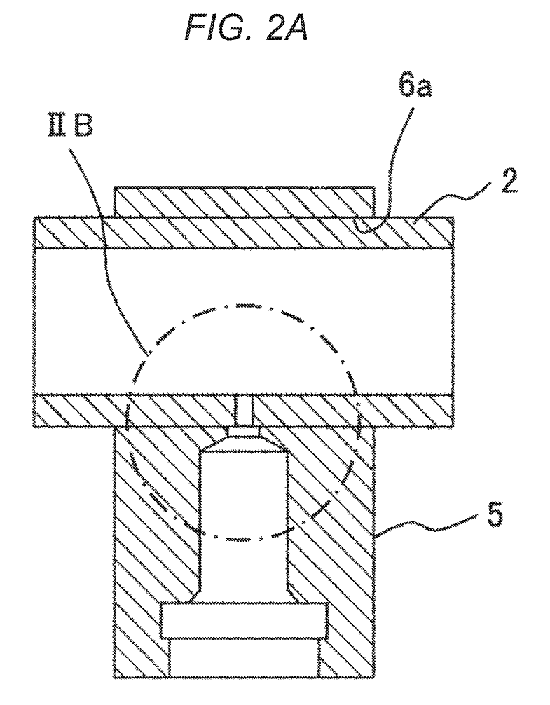

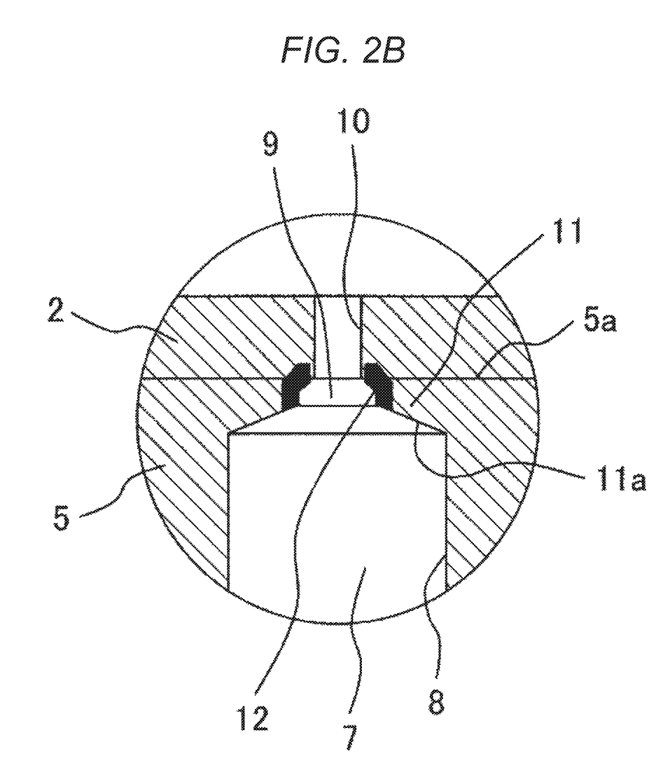

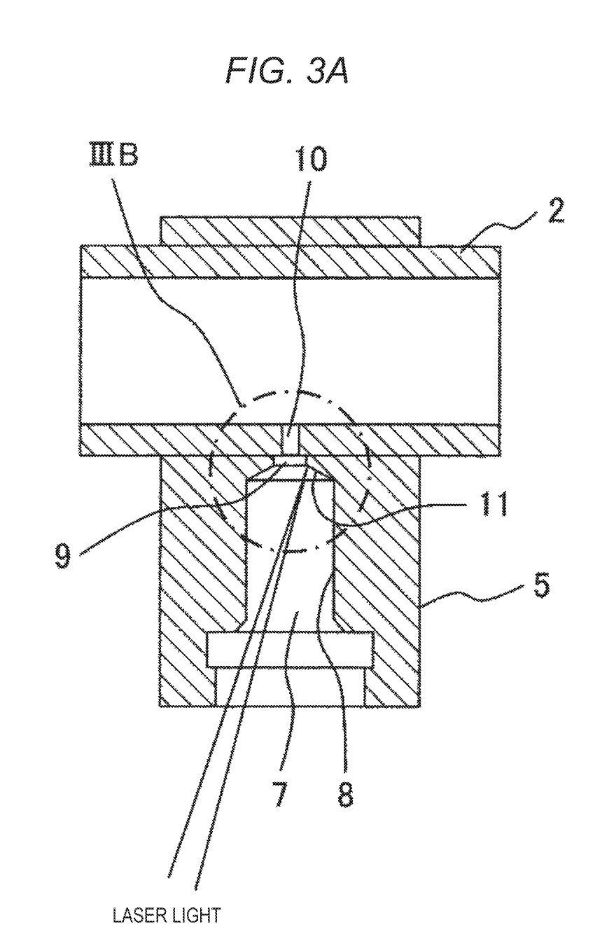

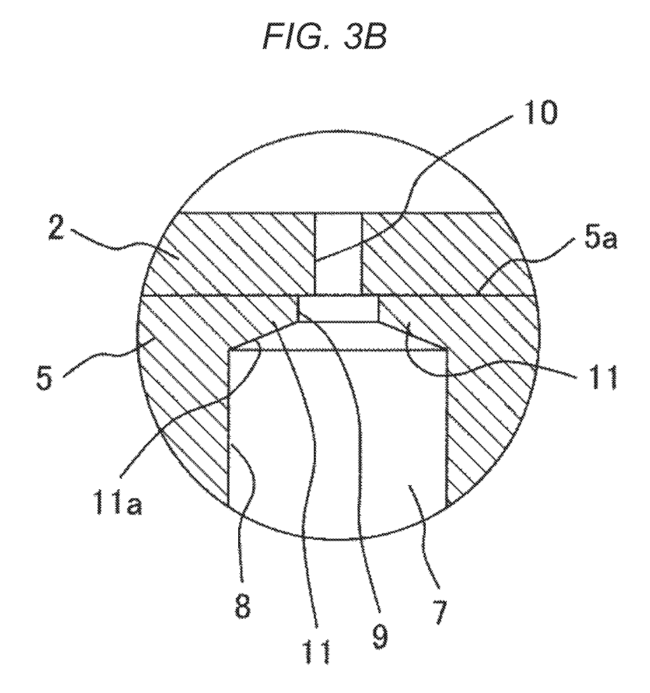

A bonding structure between the rail main unit 2 and the injector cup 5 will be described below with reference to FIGS. 2A to 3B. FIG. 2A is an enlarged cross-sectional view illustrating a portion indicated by IIA in FIG. 1A. FIG. 2B is an enlarged cross-sectional view illustrating a root portion of an injector cup mounting portion (enlarged cross-sectional view illustrating a portion indicated by IIB in FIG. 2A). FIG. 3A is an enlarged cross-sectional view illustrating a laser welding condition. FIG. 3B is an enlarged cross-sectional view illustrating a condition of the root portion of the injector cup mounting portion before the laser welding (enlarged cross-sectional view illustrating a portion indicated by IIIB in FIG. 3A). FIG. 2B illustrates a condition after the welding process has been performed, as against what is illustrated in FIG. 3B.

Reference is made to FIG. 2A. In the present embodiment, the rail main unit 2 is passed through the through hole 6a in the injector cup 5. The injector cup 5 is thereby mounted on the rail main unit 2 such that the injector cup 5 embraces the rail main unit 2. The rail main unit-side communication hole 10 and the cup-side communication hole 9 provide communication between the rail main unit 2 and the injector insertion hole 7 in the injector cup 5, so that pressurized fuel (high-pressure fuel) is supplied from the rail main unit 2 to the injector side.

Reference is made to FIGS. 3A and 3B. Of the two communication holes 9 and 10, the one on the side of the rail main unit 2 (rail main unit-side communication hole 10) is smaller than the one on the side of the cup (cup-side communication hole 9). This arrangement allows an outer peripheral surface of the rail main unit 2 to be viewed through the cup-side communication hole 9. Specifically, the outer peripheral surface of the rail main unit 2 protrudes toward a central side from a circumferential edge of the cup-side communication hole 9. An annular flange (necked portion) 11 is disposed at a root portion of a mounting portion of the injector cup 5. The annular flange 11 necks down from a diameter of the injector sealing surface 8 to the cup-side communication hole 9. Specifically, the annular flange 11 is formed between the cup-side communication hole 9 and the injector sealing surface 8.

In the present embodiment, laser light is emitted obliquely from the side of the injector insertion hole 7 in the injector cup 5 as shown in FIGS. 3A and 3B to thereby fuse and bond together the annular flange 11 and the rail main unit 2. Specifically, the laser light is emitted through the injector insertion hole 7 to a weld on the inside of the injector cup 5. In the present embodiment, an inner peripheral surface portion of the cup-side communication hole 9 and the outer peripheral surface portion of the rail main unit 2 protruding from the circumferential edge of the cup-side communication hole 9 toward the central side, in particular, are fused and bonded with each other.

During the laser welding, sealing is achieved by fusing a corner portion of the annular flange 11 and a circumference of the rail main unit-side communication hole 10 throughout the entire periphery of a circumference of the cup-side communication hole 9. As shown in FIG. 2B, the fused portion is a fusion layer 12 of metal formed between the rail main unit 2 and the injector cup 5 and the inside of the injector cup 5 is thereby sealed from the atmosphere.

The fusion layer 12 extends partly in a wall thickness direction from the outer peripheral surface toward an inner peripheral surface side (central side) of the rail main unit 2. Specifically, the fusion layer 12 does not pass from the outer peripheral surface through the inner peripheral surface of the rail main unit 2. In the present embodiment, the fusion layer 12 functions as a seal and high-pressure fuel does not permeate through a gap formed in a bond between an end face 5a of the injector cup 5 and the outer peripheral surface of the rail main unit 2. Pressure of the high-pressure fuel is thereby prevented from acting on the bond between the end face 5a of the injector cup 5 and the outer peripheral surface of the rail main unit 2.

In the present embodiment, the seal by the fusion layer 12 is required to be provided only in a small range of the inner peripheral portion of the cup-side communication hole 9 on the inside of the injector cup.

In the present embodiment, the embracing portion 6 bears all or the great part of a force to fix the injector cup 5 to, or support the injector cup 5 on, the rail main unit 2 and the fusion layer 12 assumes the sealing function. This allows amounts of the rail main unit 2 and the injector cup 5 fused by the laser welding to be reduced. The embracing portion 6 of the injector cup 5 and the rail main unit 2 may be connected with each other by press-fitting. Under a condition in which fuel pressure is being applied, the rail main unit 2 receives a force to enlarge an outside diameter thereof by the fuel pressure. Thus, the press-fitting amount is not required to be so large. The press-fitting amount is required only such that positional deviation does not occur between the embracing portion 6 of the injector cup 5 and the rail main unit 2.

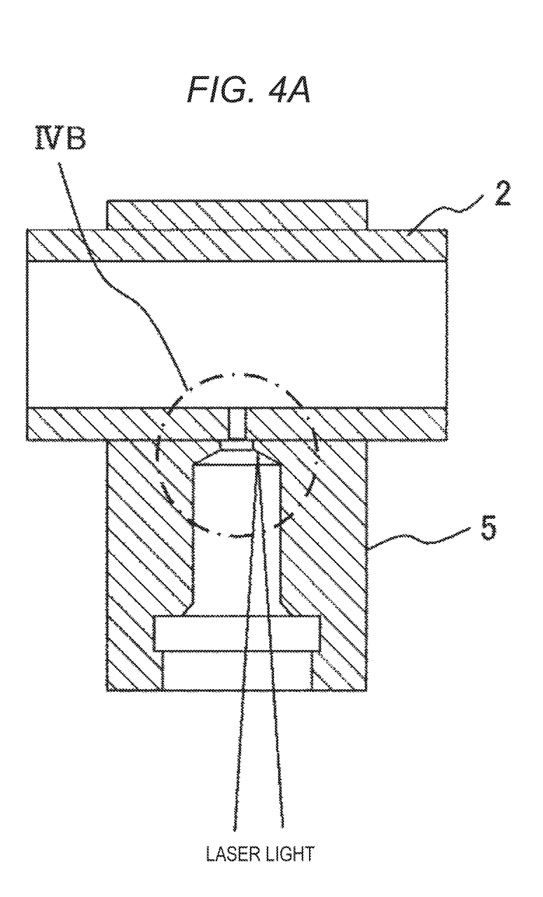

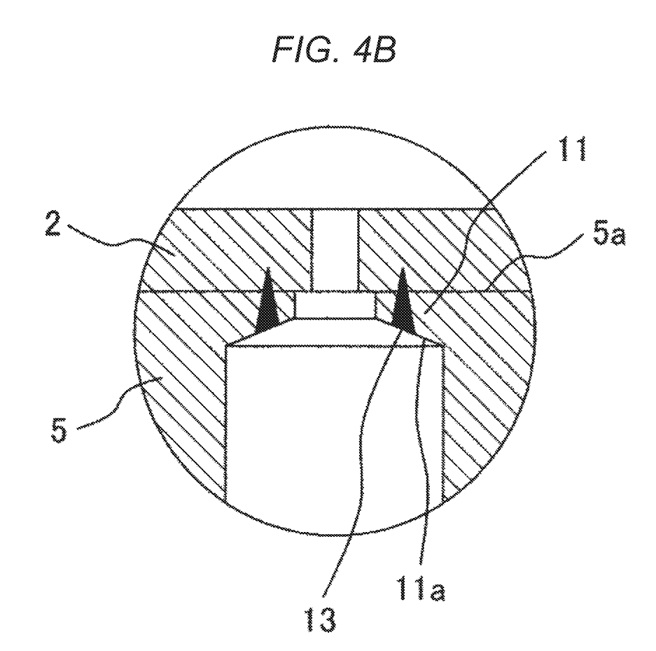

A laser welding variation will be described below with reference to FIGS. 4A and 4B. FIG. 4A is an enlarged cross-sectional view illustrating a laser welding variation. FIG. 4B is an enlarged cross-sectional view illustrating a welding condition after the laser welding variation of FIG. 4A (enlarged cross-sectional view illustrating a portion indicated by IVB in FIG. 4A).

In the present variation, laser light is emitted at an angle identical to an angle of the axis of the injector cup 5 (axis or centerline of the injector insertion hole 7) to weld the entire periphery of the cup-side communication hole 9. A fusion zone produced by this laser welding extends from the side of a taper surface 11a of the annular flange 11 to the side of the end face 5a on the side of the rail main unit 2, further reaching into the rail main unit 2. A fusion layer 13 extends partly in the wall thickness direction from the outer peripheral surface toward the inner peripheral surface side (central side) of the rail main unit 2. Specifically, the fusion layer 13 does not pass through the rail main unit 2 from the outer peripheral surface to the inner peripheral surface. As such, in the present embodiment, the metal fusion layer 13 is formed across the two parts of the injector cup 5 and the rail main unit 2.

In the present variation, the fusion zone 13 is formed outwardly in a radial direction with respect to the inner peripheral surface of the cup-side communication hole 9 and a machined surface generated when the cup-side communication hole 9 has been formed is left on the inner periphery of the cup-side communication hole 9.

In the present variation, fuel permeates in a direction in which the fuel leaks from a bond between the outer peripheral surface of the rail 2 and the end face 5a of the injector cup 5 to the outside air. The fusion layer 13, however, blocks the fuel that has permeated to the bonding surface from permeating to the outside air. In the present variation, too, the seal by the fusion layer 13 is required to be provided only in a small range around the cup-side communication hole 9 inside the injector cup. The seal provided by the fusion layer 13 eliminates the likelihood that the fuel will leak.

In accordance with the present embodiment including the variation, the high-pressure fuel causes pressure to press the end face 5a from the taper surface 11a side up against the outer peripheral surface of the rail main unit 2 to be applied to the annular flange 11. Additionally, pressure is applied to the rail main unit 2 to press the outer peripheral surface from the inner peripheral surface side up against the end face 5a of the injector cup 5. Thus, pressure acting on the taper surface 11a and pressure acting on the inner peripheral surface of the rail main unit 2 act as pressure to closely fit the bonding surface between the injector cup 5 and the rail main unit 2.

In the present variation described above, pressure of high-pressure fuel that has entered the gap formed in a range between an inner peripheral edge of the cup-side communication hole 9 and the fusion layer 13 acts as pressure to press to widen the bonding surface between the injector cup 5 and the rail main unit 2. The gap is, however, formed in a micro-range near the inner peripheral edge of the cup-side communication hole 9. Thus, the range (area) on which the pressure to press to widen the bonding surface between the injector cup 5 and the rail main unit 2 is extremely small compared with the range (area) on which the above-described pressure to closely fit the bonding surface acts.

In the embodiment described with reference to FIGS. 2A to 3B, no high-pressure fuel enters the bonding surface between the injector cup 5 and the rail main unit 2, and thus the pressure to press to widen the bonding surface does not act. The fusion layers 12 and 13 each can offer sealing performance from a small fusion width dimension and a small fusion depth dimension.

In addition, pressure causes high stress to concentrate on an entrance corner portion on the inside diameter side of the rail-side communication hole 10. The injector cup 5 is, however, fixed in an embraced manner and the fusion layer 12 or 13 is provided around the communication hole 10. These arrangements prevent the rail main unit 2 from being deformed and thus can respond to higher fuel pressure without the need to increase the wall thickness excessively or enhance weld strength.

Known structures require that the outside of the injector cup 5 be welded throughout an entire periphery thereof and force acts to widen the bond between the rail main unit 2 and the injector cup 5 because of the welding process performed not on the inside.

In the present embodiment, the cup-side communication hole 9 has a diameter smaller than a diameter of the injector insertion hole 7 (injector sealing surface 8) and the annular flange 11 is formed on a shoulder portion between the cup-side communication hole 9 and the injector insertion hole 7 (injector sealing surface 8). A surface irradiated with the laser light is formed inwardly in the radial direction of the inner peripheral surface of the injector insertion hole 7 (injector sealing surface 8). Thus, the fusion layers 12 and 13 are formed inwardly in the radial direction of the inner peripheral surface of the injector insertion hole 7 (injector sealing surface 8). This arrangement enables sealing in the bond involving a small amount of fused metal during laser welding.

### Second Embodiment

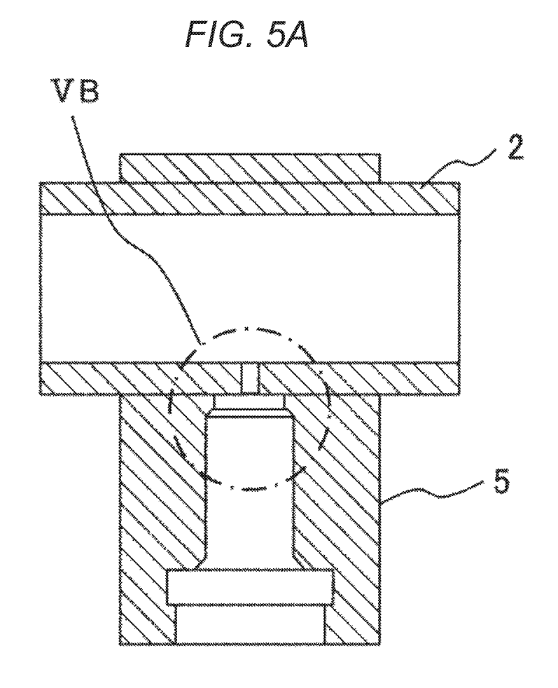

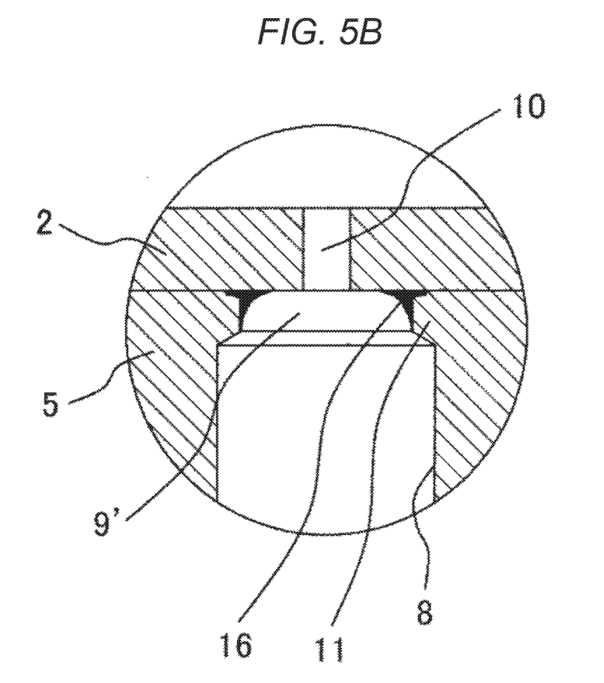

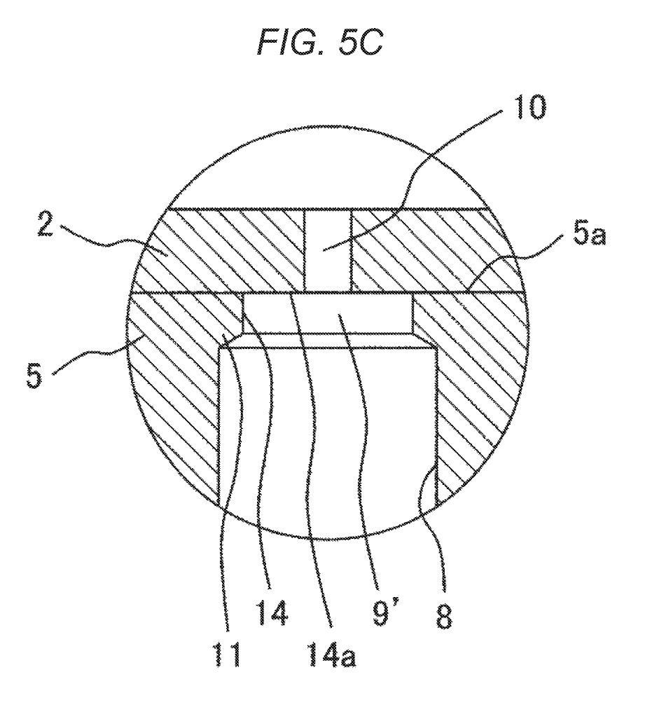

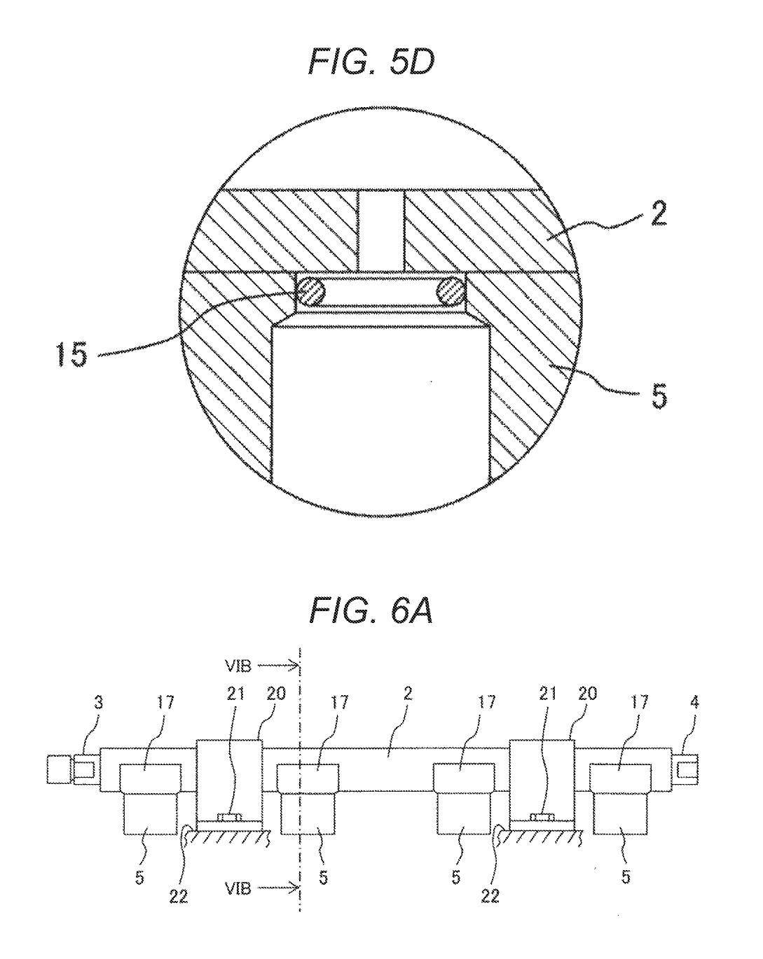

A second embodiment will be described with reference to FIGS. 5A to 5D. FIG. 5A is an enlarged cross-sectional view illustrating part of a fuel rail according to a second embodiment of the present invention. FIG. 5B is an enlarged cross-sectional view illustrating a portion indicated by VB in FIG. 5A (enlarged cross-sectional view illustrating a bonding state after brazing). FIG. 5C is an enlarged cross-sectional view illustrating an injector cup mounting portion before brazing. FIG. 5D is an enlarged cross-sectional view illustrating a brazed condition.

In the present embodiment, a metal fusion layer 16 that constitutes a seal between an injector cup 5 and a rail main unit 2 has a configuration that differs from a configuration of the fusion layers 12 and 13 in the first embodiment. The change in the configuration of the metal fusion layer 16 results in a change in part of the configuration of the injector cup 5. The second embodiment is otherwise similar to the first embodiment. The following details the differences from the first embodiment.

In the present embodiment, a communication hole 9′ on the injector cup 5 side has a diameter larger than a diameter of a rail main unit-side communication hole 10. The cup-side communication hole 9′ further has an annular shoulder portion 14. A difference in diameter between the cup-side communication hole 9′ and the rail main unit-side communication hole 10 in the present embodiment is greater than a difference in diameter between the cup-side communication hole 9 and the rail main unit-side communication hole 10 in the first embodiment. Specifically, in the present embodiment, the difference in diameter between the cup-side communication hole 9′ and the rail main unit-side communication hole 10 is greater than the diameter of the rail main unit-side communication hole 10. In contrast, in the first embodiment, the difference in diameter between the cup-side communication hole 9 and the rail main unit-side communication hole 10 is smaller than the diameter of the rail main unit-side communication hole 10. Through the foregoing arrangements, a bottom surface portion 14a of the annular shoulder portion 14 is formed to surround the rail main unit-side communication hole 10. The bottom surface portion 14a has a width (width dimension) equivalent to ½ of the difference in diameter between the cup-side communication hole 9′ and the rail main unit-side communication hole 10.

Reference is made to FIG. 5D. A brazing filler metal 15 such as a copper brazing filler metal is disposed on an inner periphery of the annular shoulder portion 14 and the area near the brazing filler metal 15 is heated to melt the filler metal. Exemplary methods of heating include, but are not limited to, loading the general rail in a furnace, heating the area using a high-frequency current, and emitting a laser beam from the side of the injector cup 5 to perform local heating. The molten filler metal forms the metal fusion layer 16 having a fillet shape on the annular shoulder portion 14, near an area around the rail main unit-side communication hole 10, and faying surfaces of the rail main unit 2 and the injector cup 5.

In the present embodiment, the diameter of the cup-side communication hole 9′ is smaller than a diameter of an injector insertion hole 7 (injector sealing surface 8) and an annular flange 11 is formed at a shoulder portion between the cup-side communication hole 9′ and the injector insertion hole 7 (injector sealing surface 8). In the present embodiment, a surface on which the brazing filler metal is disposed (brazing surface) is set inwardly of an inner peripheral surface of the injector insertion hole 7 (injector sealing surface 8) in a radial direction. Thus, the metal fusion layer 16 is formed inwardly of the inner peripheral surface of the injector insertion hole 7 (injector sealing surface 8) in the radial direction. This enables sealing in a bond using a reduced amount of the brazing filler metal during brazing.

In the present embodiment, the fillet-shaped fusion layer 16 functions as a seal to thereby eliminate a likelihood that high-pressure fuel will permeate through a gap formed between an end face 5a of the injector cup 5 and an outer peripheral surface of the rail main unit 2. Fuel leakage can thereby be prevented. Additionally, pressure by the high-pressure fuel can be prevented from acting as pressure to press to widen the bond between the end face 5a of the injector cup 5 and the outer peripheral surface of the rail main unit 2. The seal provided by the fusion layer 16 is required to be disposed at only a small range on an inner peripheral portion of the cup-side communication hole 9′ on the inside of the injector cup. Thus, sealing performance can be achieved with a small fusion zone.

### Third Embodiment

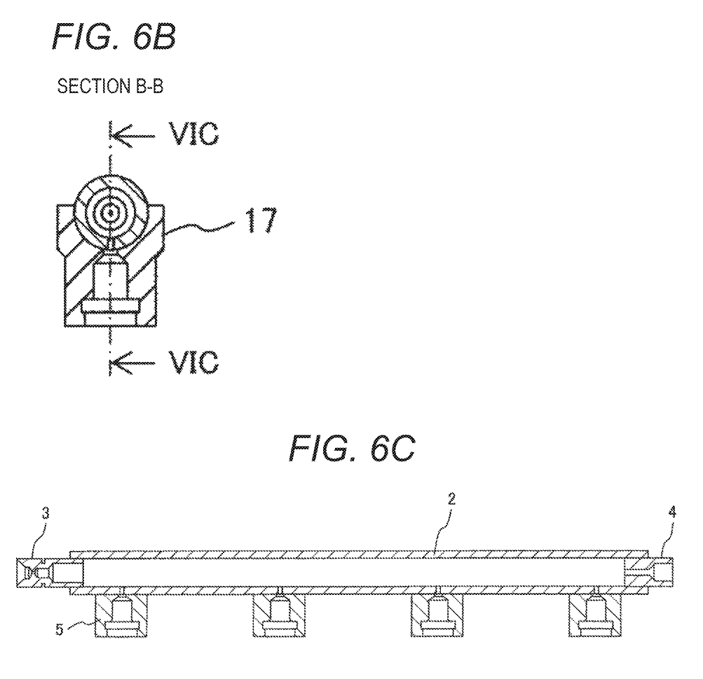

A third embodiment will be described with reference to FIGS. 6A to 6C. FIG. 6A is a view illustrating appearance of a general fuel rail according to a third embodiment of the present invention. FIG. 6B is a cross-sectional view taken along line VIB-VIB in FIG. 6A. FIG. 6C is a cross-sectional view illustrating the general fuel rail according to the third embodiment of the present invention (cross-sectional view taken along line VIC-VIC in FIG. 6B).

In the present embodiment, an embracing portion 6′ of an injector cup 5 has a configuration that differs from the configuration of the embracing portion 6 in the first embodiment. The third embodiment is otherwise similar to the first embodiment. The following details the differences from the first embodiment.

In the present embodiment, the embracing portion 6′, which embraces a rail 2, of the injector cup 5 is not configured so as to embrace an entire periphery of the rail main unit 2 as described previously. The embracing portion 6′ is required only to embrace a range that is greater than ½ in a circumferential direction of the outer periphery of the rail main unit 2. The embracing of the range greater than ½ achieves an effect identical to the effect achieved by the embracing of the entire periphery. The reduction in weight of the injector cup 5 enables reduction in weight of a fuel rail 1.

The configuration of the embracing portion 6′ of the injector cup 5 in the present embodiment is applicable to the second embodiment. Alternatively, the embracing portion 6′ of the present embodiment may be applied to the injector cup 5 described with reference to the first embodiment (including the variation).

In accordance with the embodiments of the present invention, sealing from the inside of the injector cup 5 the areas around the communication holes 9, 9′, and 10 that provide communication between the injector cup 5 and the rail main unit 2 enables sealing between the injector cup 5 and the rail main unit 2 to be performed reliably, involving a short welding distance or a reduced amount of the brazing filler metal. Response to higher fuel pressure can be promoted and an excessive increase in the wall thickness or an increase in weight can be prevented.

### REFERENCE SIGNS LIST

1 high-pressure fuel rail
2 rail main unit
3 inlet
4 sensor boss
5 injector cup
6 embracing portion
6′ embracing portion
7 injector insertion hole
8 injector sealing surface
9 cup-side communication hole
9′ cup-side communication hole
10 rail main unit-side communication hole
11 annular flange
12 fusion layer
13 fusion layer
14 annular shoulder portion
14a bottom surface portion of annular shoulder portion
15 brazing filler metal
16 fusion layer

1. A fuel rail comprising:
a rail main unit; and
an injector receiving member,
the rail main unit having a central hole, disposed at a central portion thereof, extending in an axial direction and a rail main unit-side communication hole providing communication between the central hole and an outside of the rail main unit, the injector receiving member having an injector insertion hole into which an injector is inserted, the injector receiving member being disposed in the rail main unit such that the rail main unit-side communication hole and the injector insertion hole communicate with each other, wherein
the injector receiving member has an injector receiving member-side communication hole providing communication between the rail main unit-side communication hole and the injector insertion hole, and
a metal fusion zone is formed, by way of an inside of the injector receiving member, in a bond between the rail main unit and the injector receiving member, to seal the bond.

2. The fuel rail according to claim 1, wherein the injector receiving member includes a fixing portion that embraces a range of an outer periphery of the rail in a circumferential direction, the range being equivalent to one round or more than a half round of the outer periphery of the rail.

3. The fuel rail according to claim 2, wherein the fusion zone is formed by bonding surfaces of the rail main unit and the injector receiving member being bonded with each other by laser welding.

4. The fuel rail according to claim 3, wherein
the injector receiving member includes an annular flange portion disposed around the injector receiving member-side communication hole, and
the fusion zone is formed by overlapping portions of the annular flange portion and the rail main unit being bonded with each other by laser welding.

5.The fuel rail according to claim 4, wherein
the rail main unit-side communication hole has a diameter smaller than a diameter of the injector receiving member-side communication hole,
the rail main unit has a protrusion that protrudes inwardly from an inner peripheral edge of the injector receiving member-side communication hole, and
the fusion zone is formed across an inner peripheral surface of the injector receiving member-side communication hole and the protrusion of the rail main unit.

6. The fuel rail according to claim 4, wherein
the fusion zone is formed outwardly of the inner peripheral surface of the injector receiving member-side communication hole in a radial direction, and
a machined surface of the injector receiving member-side communication hole is left on the inner periphery of the injector receiving member-side communication hole.

7. The fuel rail according to claim 2, wherein
the fusion zone is formed by the bonding surfaces of the rail main unit and the injector receiving member being brazed with each other.

8. The fuel rail according to claim 7, wherein
the injector receiving member includes an annular step portion disposed around the injector receiving member-side communication hole, and
the fusion zone is formed by a brazing filler metal layer extending from an inner periphery of the annular step portion to the bond between the injector receiving member and the rail main unit.
